(19) United States
(12) Patent Application Publication
(10) Pub. No.: US 2005/0071570 A1
(43) Pub. Date: Mar. 31, 2005

(54) Prefetch controller for controlling retrieval of data from a data storage device

(76) Inventors: Robin Alexis Takasugl, Eagle, ID (US); Stewart R. Wyatt, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/672,975

(22) Filed: Sep. 26, 2003

(51) Int. Cl. G06F 12/00

(52) U.S. Cl. 711/137

(57) ABSTRACT

A prefetch controller controls retrieval of data from a data storage device in response to a current host command received from a host device. The prefetch controller includes a sequential read detector configured to generate a new sequential read indication for the current host command if the current host command and a previously received host command specify read operations that are non-sequential. The prefetch controller includes a transfer length generator configured to provide a first transfer length value to the data storage device if the new sequential read indication is generated for the current host command, and provide a second transfer length value to the data storage device if the new sequential read indication is not generated for the current host command.

### THE FIELD OF THE INVENTION

The present disclosure generally relates to data storage devices, and more particularly to a prefetch controller for controlling retrieval of data from a data storage device.

### BACKGROUND OF THE INVENTION

Data storage devices, such as a disk drive, tape drive, flash memory, or other device that stores data, typically have a controller for interfacing with a host device. The host device sends the controller information about a requested transfer, which typically includes an indication of transfer direction (e.g., READ or WRITE), and address information (e.g., an address and a transfer length or size). For a READ operation, the address typically indicates the starting place on the storage media where the data to be transferred is stored.

Data storage devices are typically used in sequential access mode, random access mode, or a combination of both modes. In sequential access mode, the transfers start at contiguous addresses (e.g., if transfer N starts at address 1234 and requests 10 data units; transfer N+1 will start at address 1244 and ask for some number of data units). The address of the first requested data unit of any request is one more than the address of the last data unit of the previous request. The size of the data units is device dependent. For example, in some devices, each data unit is a 512-byte block of data, so each request that specifies a length of one data unit, would be requesting one 512-bit block.

An example of a data storage device that operates in a sequential access mode is a Small Computer System Interface (SCSI) tape drive. For a SCSI tape drive, a host typically sends a special command to the tape drive to set the start address. Then each READ or WRITE command from the host contains a length, but no address, as the address is assumed to be sequential to that of the previous command. To break the stream of sequential accesses, the host sends a new starting address in a separate command.

Data storage devices typically include a buffer for temporarily storing data being transferred between the storage media and the host. In sequential access mode, system performance can be improved when reading by continuing to fill the buffer with sequential data even after the last of the data from the current request has left the buffer on its way to the host. By continuing to fill the buffer with data, the buffer will most likely be partially or wholly filled by the time the next host request is executed, thereby improving performance. The amount of data beyond the end of a given transfer, which will likely be part of the next transfer, is called “prefetch,” and the amount is usually enough to fill the buffer once the last of the data for the current request has left the buffer.

In memory controller architectures that use firmware to program the storage media for each transfer of data, the firmware programs the prefetch as a separate internal transfer following the current transfer requested by the host. Programming a prefetch as a separate internal transfer in this manner consumes a relatively large amount of time.

### SUMMARY OF THE INVENTION

One form of the present invention provides a prefetch controller for controlling retrieval of data from a data storage device in response to a current host command received from a host device. The prefetch controller includes a sequential read detector configured to generate a new sequential read indication for the current host command if the current host command and a previously received host command specify read operations that are non-sequential. The prefetch controller includes a transfer length generator configured to provide a first transfer length value to the data storage device if the new sequential read indication is generated for the current host command, and provide a second transfer length value to the data storage device if the new sequential read indication is not generated for the current host command.

### BRIEF DESCRIPTION OF THE DRAWINGS

FIG. 1 is a block diagram illustrating a computing system according to one embodiment of the present invention.

FIG. 2 is a block diagram illustrating major components of the host interface shown in FIG. 1 according to one embodiment of the present invention.

FIG. 3 is a block diagram illustrating major components of the sequential read detector shown in FIG. 2 according to one embodiment of the present invention.

FIG. 4 is a block diagram illustrating major components of the input/output controller shown in FIG. 1 according to one embodiment of the present invention.

FIG. 5 is a diagram illustrating a plurality of addresses for identifying storage locations within the data storage device shown in FIG. 1 according to one embodiment of the present invention.

FIG. 6 is a flow diagram illustrating a method for performing a memory prefetch according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

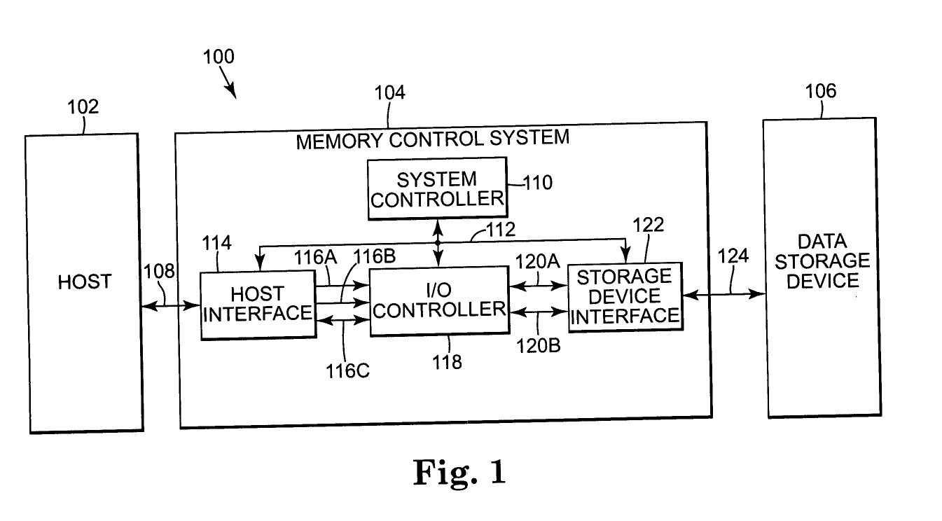

FIG. 1 is a block diagram illustrating a computing system 100 according to one embodiment of the present invention. Computing system 100 includes a host electronic device 102, a memory control system 104, and a data storage device (storage media) 106. Host electronic device 102 and memory control system 104 are communicatively coupled together via communication link 108. Memory control system 104 and data storage device 106 are communicatively coupled together via communication link 124.

In one embodiment, host electronic device 102 is a portable electronic device, such as a digital camera, MP3 player, digital camcorder, personal digital assistant (PDA), laptop computer, or notebook computer. In one form of the invention, memory control system 104 and data storage device 106 are implemented together in the form of a removable memory card that is configured to be inserted into and removed from host electronic device 102. In one embodiment, data storage device 106 is a non-volatile memory, such as a flash memory, magnetic random access memory (MRAM), disk drive, tape drive, or other device for storing data. In another embodiment, data storage device 106 is a volatile memory, such as a static RAM (SRAM) or dynamic RAM (DRAM). It will be understood by persons of ordinary skill in the art that the techniques disclosed herein are applicable to other types of host devices and data storage devices, including non-portable devices, such as a desktop computer and a SCSI disk drive.

In one embodiment, memory control system 104 includes system controller 110, host interface 114, input/output (I/O) controller 118, and storage device interface 122. Controller 110 is in communication with host interface 114, I/O controller 118, and storage device interface 122 via communication link 112. Host interface 114 is in communication with host electronic device 102 via communication link 108, and with I/O controller 118 via communication links 116A-116C (collectively referred to as communication links 116). I/O controller 118 is in communication with storage device interface 122 via communication links 120A-120B (collectively referred to as communication links 120). Storage device interface 122 is in communication with data storage device 106 via communication link 124.

Controller 110 interacts with host interface 114, I/O controller 118, and storage device interface 122 to execute commands and transfer data between host electronic device 102 and data storage device 106. In one form of the invention, memory control system 104 is implemented in an application specific integrated circuit (ASIC). In one embodiment, controller 110 is implemented with firmware running on an embedded microprocessor. In one embodiment, host interface 114, 110 controller 118, and data storage device interface 122 are implemented in hardware (e.g., programmable logic device or state machine).

In one embodiment, controller 110 communicates with host electronic device 102 using the same communications protocol as host electronic device 102. Controller 110 receives host commands (e.g., a READ command or a WRITE command) from host electronic device 102 via host interface 114 and communication link 112. In one embodiment, when a host command is received by controller 110, controller 110 configures host interface 114, 110 controller 118, and storage device interface 122 to execute the host command.

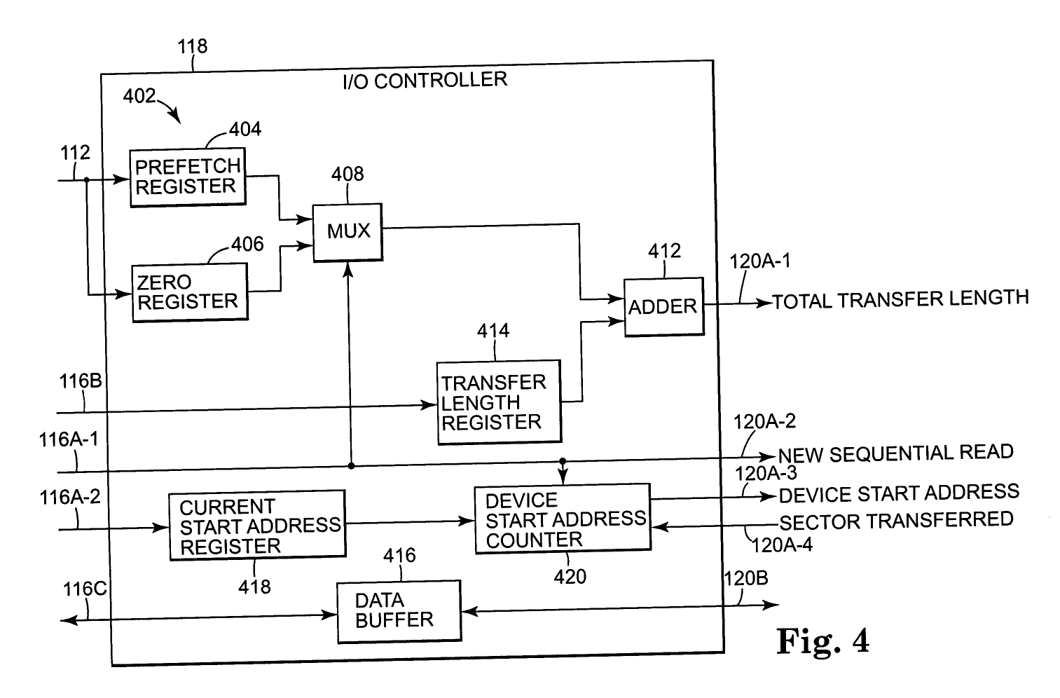

For a WRITE command, I/O controller 118 initiates the data transfer by requesting data (e.g., in data blocks or bytes) from host interface 114. I/O controller 118 continues to receive data from host interface 114 until a complete block of data (e.g., a sector) has been received. The received data is stored in a buffer 416 (shown in FIG. 4) within I/O controller 118. When a complete block of data has been received, I/O controller 118 notifies storage device interface 122 that a complete data block is available, and directs storage device interface 122 to allocate a storage location the size of the data block in data storage device 106. Storage device interface 122 allocates the storage location in data storage device 106 and transfers the data block from the I/O controller 118 to data storage device 106.

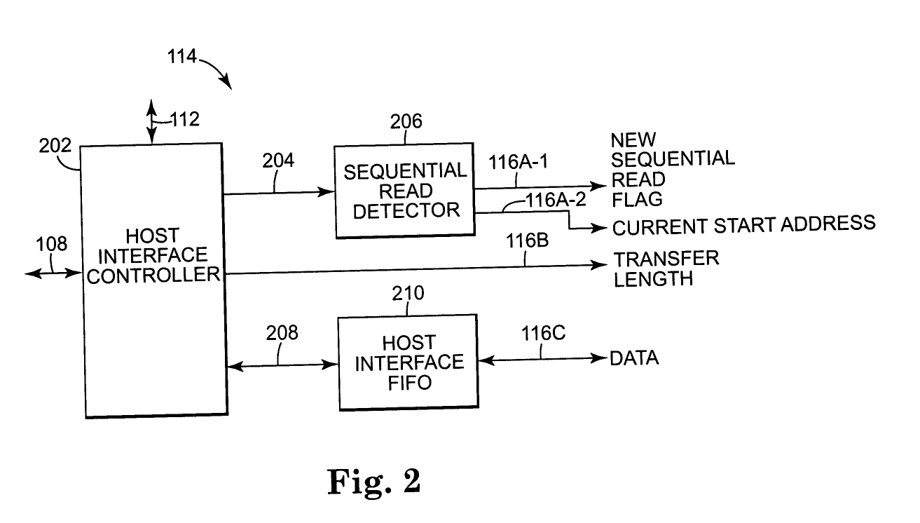

For a READ command, I/O controller 118 initiates the data transfer by communicating with the storage device interface 122 to request a block of data from the data storage device 106. The storage device interface 122 communicates with data storage device 106 to retrieve the block of data and transfer the data to I/O controller 118. In one embodiment, the data block is stored in buffer 416 (shown in FIG. 4) within I/O controller 118. Storage device interface 122 then notifies system controller 110 and 110 controller 118 that the data block is available for retrieval by host interface 114. Host interface 114 retrieves the data block from the I/O controller 118 and transfers the data block to host electronic device 102. In one embodiment, for sequential READ operations, the storage device interface 122 also retrieves a set of prefetch data from data storage device 106, which is stored in I/O controller 118 for a subsequent READ command. The retrieval of prefetch data according to one form of the present invention is described in further detail below with reference to FIGS. 2-6.

In one embodiment, controller 110 performs error detection and correction, as well as sparing algorithms to improve storage efficiency of data storage device 106. In one form of the invention, host READ and WRITE commands are based on logical block addressing. In one aspect of the invention, controller 110 uses look-up tables to look up a logical block address included in a host command and determine a physical address within data storage device 106.

In one form of the invention, data storage device 106 is accessible via either a sequential access mode or a random access mode. The host electronic device 102 sends information about the requested transfer, including an indication of transfer direction (e.g., READ or WRITE) and address information to the memory control system 104. The address information indicates the starting place in the data storage device 106 where the requested data is located.

FIG. 2 is a block diagram illustrating major components of the host interface 114 shown in FIG. 1 according to one embodiment of the present invention. Host interface 114 includes host interface controller 202, sequential read detector 206, and host interface first-in first-out (FIFO) buffer 210. Host interface controller 202 receives host commands from the host electronic device 102 via communication link 108, and data is transferred between the host electronic device 102 and host interface controller 202 via communication link 108.

Host interface FIFO 210 is communicatively coupled to host interface controller 202 via communication link 208, and is communicatively coupled to I/O controller 118 (FIG. 1) via communication link 116C. Host interface FIFO 210 provides for the temporary storage of data received from, or to be transferred to, host electronic device 102.

In one embodiment, READ and WRITE host commands include an opcode, a start address, and a transfer length. The opcode identifies whether the command is a READ command or a WRITE command. For a READ command, the start address identifies the starting place in the data storage device 106 where the data to be transferred to the host 102 is currently stored. For a WRITE command, the start address identifies the starting place in the data storage device 106 where the data transferred from the host 102 is to be stored.

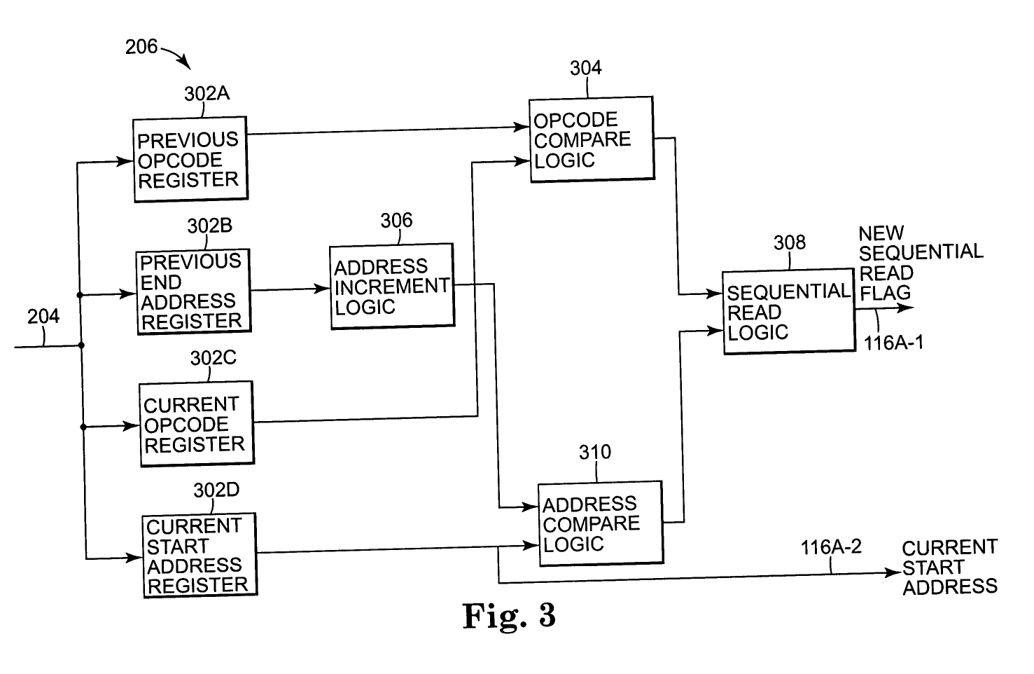

In one embodiment, for each host command received from host electronic device 102, host interface controller 202 outputs the opcode and addressing information for the host command to sequential read detector 206 via communication link 204, and outputs the transfer length specified by the host command to 110 controller 118 (FIG. 1) via communication link 116B. As described in further detail below with reference to FIG. 3, based on opcodes and addressing information received from host interface controller 202, sequential read detector 206 determines whether host electronic device 102 has requested a new sequential READ, and if so, outputs a new sequential read flag with a logical true value to I/O controller 118 via communication link 116A-1. Sequential read detector 206 also outputs the start address specified by the current the host command to the I/O controller 118 via communication link 116A-2.

FIG. 3 is a block diagram illustrating major components of the sequential read detector 206 shown in FIG. 2 according to one embodiment of the present invention. Sequential read detector 206 includes registers 302A-302D (collectively referred to as registers 302), opcode compare logic 304, address increment logic 306, sequential read logic 308, and address compare logic 310. In one form of the invention, registers 302 are programmed by the host interface controller 202 (FIG. 2) via the communication link 204 based on the host commands received from host electronic device 102.

Register 302A (previous opcode register) holds the opcode specified in the host command received prior to the current host command. Register 302B (previous end address register) holds the end address for the host command received prior to the current host command, which is determined based on the start address and the transfer length specified in the previous host command. Register 302C (current opcode register) holds the opcode specified in the current host command. Register 302D (current start address register) holds the start address specified in the current host command.

In one embodiment of the invention, for each received host command, host interface controller 202 (FIG. 2) copies the “old” opcode in current opcode register 302C to previous opcode register 302A, and loads the end address for this “old” opcode into previous end address register 302B. And host interface controller 202 loads the opcode specified in the newly received host command into current opcode register 302C, and loads the start address specified in the newly received host command into current start address register 302D.

During each command execution cycle, the previous opcode stored in register 302A and the current opcode stored in register 302C are provided to opcode compare logic 304, which compares the two received opcodes and determines whether they both specify READ operations. If both opcodes specify READ operations, opcode compare logic 304 outputs a sequential read indication to sequential read logic 308.

During each command execution cycle, the previous end address stored in register 302B is incremented by one by address increment logic 306, and the incremented address is provided to address compare logic 310. The current start address stored in register 302D is also provided to address compare logic 310. Address compare logic 310 compares the two received addresses and determines whether the addresses are equal. If the addresses are equal, address compare logic 310 outputs a sequential read indication to sequential read logic 308. The current start address stored in register 302D is also output to I/O controller 118 via communication link 116A-2.

If sequential read logic 308 receives a sequential read indication from both opcode compare logic 304 and address compare logic 310, sequential read logic 308 outputs a new sequential read flag with a logical false value to I/O controller 118 (FIG. 1) via communication link 116A-1. The logical false value for the new sequential read flag indicates that the current transfer is not a new sequential READ. If sequential read logic 308 receives a sequential read indication from only one of opcode compare logic 304 or address compare logic 310, or does not receive a sequential read indication from either of opcode compare logic 304 or address compare logic 310, sequential read logic 308 outputs a new sequential read flag with a logical true value to I/O controller 118 via communication link 116A-1. The logical true value for the new sequential read flag indicates that the current transfer is not sequential to the previous transfer, but may be the first in a series of sequential READ operations.

In another embodiment of the present invention, rather than generating the new sequential read flag with hardware shown in FIG. 3, firmware within controller 110 detects when new sequential READs occur and generates new sequential read flags that are provided to I/O controller 118.

FIG. 4 is a block diagram illustrating major components of the input/output (I/O) controller 118 shown in FIG. 1 according to one embodiment of the present invention. I/O controller 118 includes prefetch controller 402 and data buffer 416. Prefetch controller 402 includes prefetch register 404, zero register 406, multiplexer (MUX) 408, adder 412, transfer length register 414, current start address register 418, and device start address counter 420. The communication links 116A-1 and 116A-2 shown in FIG. 4 are collectively referred to herein as communication links 116A, and the communication links 120A-1 to 120A-4 are collectively referred to herein as communication links 120A.

In one embodiment, registers 404 and 406 are programmed by controller 110 (FIG. 1) via communication link 112 at start-up of memory control system 104. In one form of the invention, prefetch register 404 is programmed with a non-zero value that is less than or equal to the number of blocks in buffer 416, and zero register 406 is programmed with a “0” value. During each command execution cycle, the values stored in registers 404 and 406 are both provided to multiplexer 408, which outputs one of the two values to adder 412 based on a signal received on communication link 116A-1 from sequential read logic 308 (FIG. 3). In one embodiment, if sequential read logic 308 outputs a logically true new sequential read flag for the current host command to multiplexer 408 via communication link 116A-1, multiplexer 408 outputs the value stored in prefetch register 404 to adder 412. If sequential read logic 308 outputs a logically false new sequential read flag for the current host command to multiplexer 408 via communication link 116A-1, multiplexer 408 outputs the value stored in zero register 406 to adder 412. Thus, the signal output by sequential read logic 308 selectively switches the multiplexer 408 to output either a non-zero prefetch value in the case of a potentially new sequential transfer, or a zero if the current transfer is not a new sequential transfer.

As described above with reference to FIG. 2, for each host command received from host electronic device 102, host interface controller 202 outputs the transfer length for the host command to 110 controller 118 via communication link 116B. The transfer length is stored in register 414. In another embodiment, firmware within controller 110 (FIG. 1) loads register 414 with the transfer length for the current host command. During each command execution cycle, the prefetch length value output by multiplexer 408 and the transfer length value stored in register 414 are provided to adder 412, which adds the two received values, and outputs the sum to storage device interface 122 (FIG. 1) via communication link 120A-1. The sum of the prefetch length value and the transfer length value represent the total transfer length value for the current host command. Thus, in one embodiment, for each READ command, a prefetch value is added by hardware to the transfer length value specified in the READ command, with the prefetch value varying depending upon whether the transfer is a new sequential READ or not.

Data buffer 416 is communicatively coupled to host interface FIFO 210 (FIG. 2) via communication link 116C, and is communicatively coupled to storage device interface 122 (FIG. 1) via communication link 120B. Data buffer 416 provides temporary storage of data transferred between the host interface 114 and storage device interface 122.

The new sequential read flag output by sequential read logic 308 via communication link 116A-1 is provided to the device start address counter 420, and is also output from I/O controller 118 to storage device interface 122 via communication link 120A-2. The start address specified by the current host command is loaded into current start address register 418 via communication link 116A-2. Typically, any time the new sequential read flag output by sequential read logic 308 for a current host command is logically true, the device start address counter 420 is loaded with the current start address stored in register 418. The logically true new sequential read flag is received by storage device interface 122, which responds by aborting any currently running prefetch activity, and the buffer pointers for date buffer 416 are reset to the start of the buffer 416.

At the start of each host transfer, the contents of the device start address counter 420 are passed to the storage device interface 122 to inform interface 122 where to start the device transfer. After each sector or data unit is transferred, the storage device interface 122 signals the I/O controller 118 with a sector transferred signal via communication link 120A-4, so that the start address counter 420 can be correspondingly incremented. Thus, if system 100 is in the middle of a series of sequential transfers, the start address passed to the storage device interface 122 will match the address where the data storage device 106 currently is (i.e., one prefetch length ahead of the host start address). If the current host transfer is not sequential, the device start address counter 420 is loaded from the current start address register 418, and the loaded value is transferred to the storage device interface 122.

As long as system 100 is in the middle of a sequential series of transfers, the new sequential read signal output by sequential read logic 308 will be false, causing “0” to be added to the transfer length specified in the current host command, with the result being that the transfer length provided to the storage device interface 122 is the same as the transfer length specified by the current host command, and the buffer 416 is full of prefetched data. For example, if the data buffer 416 contains sectors 100-109, and the host 102 reads four sectors, the data storage device 106 will put only four sectors into the buffer 416, maintaining the buffer's full state (i.e., if the host 102 reads sectors 100-103, the buffer 416 is left with sectors 104-113).

In one embodiment, any non-sequential READ is assumed to be the first in a potential series of sequential READs. In one form of the invention, for non-sequential READs, any old prefetch activity occurring in the storage device interface 122 is aborted, the starting address provided to storage device interface 122 is the same as the starting address specified in the current READ command, and the total transfer length provided to the storage device interface 122 is increased by the prefetch amount. In this way, after a first non-sequential READ, the buffer 416 will be full of prefetch data, and any subsequent sequential reads will ask the storage device interface 122 for the same amount of data that the host 102 is taking out of the buffer 416, leaving the buffer 416 full. And the device start address counter 420 will represent the start address specified in the current host command plus the prefetch length, and will do so until the first non-sequential transfer resets the counter 420 to the start address specified in the current host command.

For a host command specifying a READ operation, storage device interface 122 (FIG. 1) retrieves data from data storage device 106 at a location corresponding to the start address output by device start address counter 420 via communication link 120A-4, and having a size corresponding to the total transfer length output by adder 412 via communication link 120A-1. The retrieved data is transferred from the storage device interface 122 to the data buffer 416 via communication link 120B. Data buffer 416 outputs the requested data to host interface FIFO 210, where the data is temporarily stored prior to being output to the host electronic device 102. In one embodiment, data is not output from data buffer 416 until the data buffer 416 is full, at which point it begins to output data to FIFO 210. In another embodiment, data buffer 416 begins outputting data to FIFO 210 prior to being completely filled.

In one form of the invention, for each READ command, I/O controller 118 monitors the amount of retrieved data that has passed through buffer 416, and when an amount of data corresponding to the transfer length specified in the READ command has been output from the buffer 416, 110 controller 118 generates an interrupt to notify controller 110 that the last of the requested data is ready for transfer to host electronic device 102. After the requested data has been transferred to host electronic device 102, controller 110 sends status or acknowledgement information to host electronic device 102 to inform the host 102 that the transfer is complete.

For a sequential READ command that is not a new sequential READ, the total transfer length value output by adder 412 is the same as the transfer length value specified in the READ command. For a new sequential READ command, the total transfer length value output by adder 412 is larger than the transfer length specified in the READ command, with the additional length corresponding to prefetch data. In one embodiment, for a new sequential READ command, after the last of the requested data has been transferred out of buffer 416, storage device interface 122 begins to load buffer 416 with the prefetch data. In one embodiment, storage device interface 122 continues to load buffer 416 with the prefetch data during the acknowledgement phase for the requested data. The amount of prefetch data that can be loaded into buffer 416 before receipt of the next READ command varies depending upon the amount of time between host commands (inter-command time), and the speed of interfaces 114 and 122. Regardless of whether all, or only part, of the prefetch data is loaded into the buffer 416 before receipt of the next READ command, time is saved by performing the prefetch.

By retrieving and storing the prefetch data in buffer 416 during processing of the current host command, the buffered prefetch data can be provided to the host electronic device 102 more quickly in response to the next sequential READ command, than by waiting to receive the next READ command, and then beginning to retrieve the data from data storage device 106 at that time. The amount of prefetch data output by data storage device 106 depends upon the difference between the total transfer length provided to data storage device 106 by adder 412, and the transfer length specified in the current host command. If the total transfer length output by adder 412 is greater than the transfer length specified in the current host command (e.g., a non-zero prefetch length value was added to the host specified transfer length value), the difference between these two lengths indicates the amount of prefetch data that will be output by data storage device 106. If the total transfer length value output by adder 412 is equal to the transfer length specified in the current host command (e.g., a zero was added to the host specified transfer length value), the data storage device 106 will not output any prefetch data.

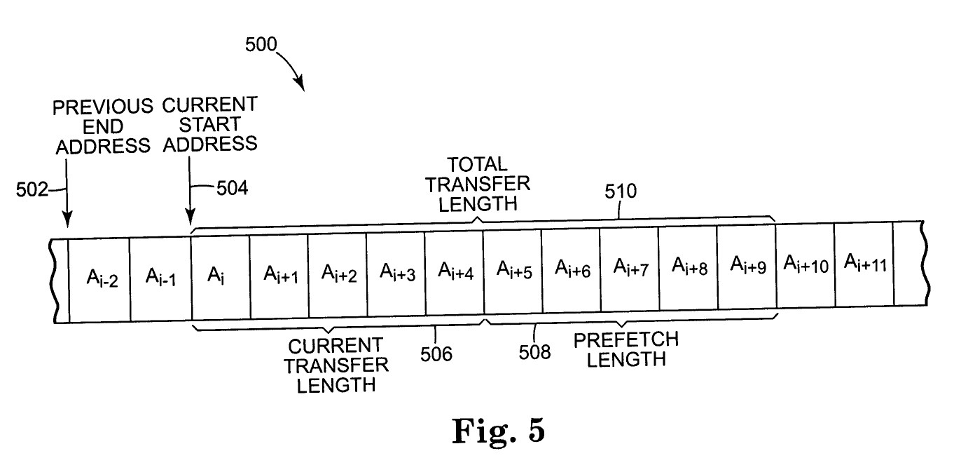

FIG. 5 is a diagram illustrating a plurality of addresses 500 for identifying storage locations within data storage device 106 according to one embodiment of the present invention. As shown in FIG. 5, the addresses range from Aᵢ₊₂ to Aᵢ₊₁. Address Aᵢ₊₂ corresponds to the end address 502 of a previously received READ command. The previous end address 502 is stored in register 302B (FIG. 3) of sequential read detector 206. Address Aᵢ corresponds to the start address 504 specified in a current READ command. The current start address 504 is stored in register 302D of sequential read detector 206. As described above, after the previous end address 502 is incremented by one, the incremented address is compared with the current start address 504, to determine whether the current host command is sequential to the previous host command. Note that the opcodes of the previous host command and the current host command are also compared in one form of the invention to verify that both commands specify READ operations. As shown in FIG. 5, the previous end address 502 and the current start address 504 differ by two. Thus, after incrementing the previous end address by a value of one, the incremented previous end address is not equal to the current start address, indicating that the current host command is non-sequential to the previous host command, but may be the first in a series of new sequential READ operations.

The transfer length 506 specified by the current READ command is five in the illustrated embodiment, so the transfer will include data corresponding to the five addresses Aᵢ through Aᵢ₊₄. The transfer length 506 is stored in register 414 (FIG. 4) of I/O controller 118. The prefetch length 508 for the illustrated embodiment is five, so the prefetch data will include data corresponding to the five addresses Aᵢ₊₅ through Aᵢ₊₉. The prefetch length 508 is stored in register 404 of I/O controller 118. The total transfer length 510 is the sum of the transfer length 506 and the prefetch length 508, which is ten for the illustrated embodiment. Thus, for the illustrated embodiment, adder 412 (FIG. 4) would output a value of ten to storage device interface 122. If the current host command was sequential to the previous host command, adder 412 would add a value of zero to the transfer length 506, and adder 412 would output a value of five to storage device interface 122.

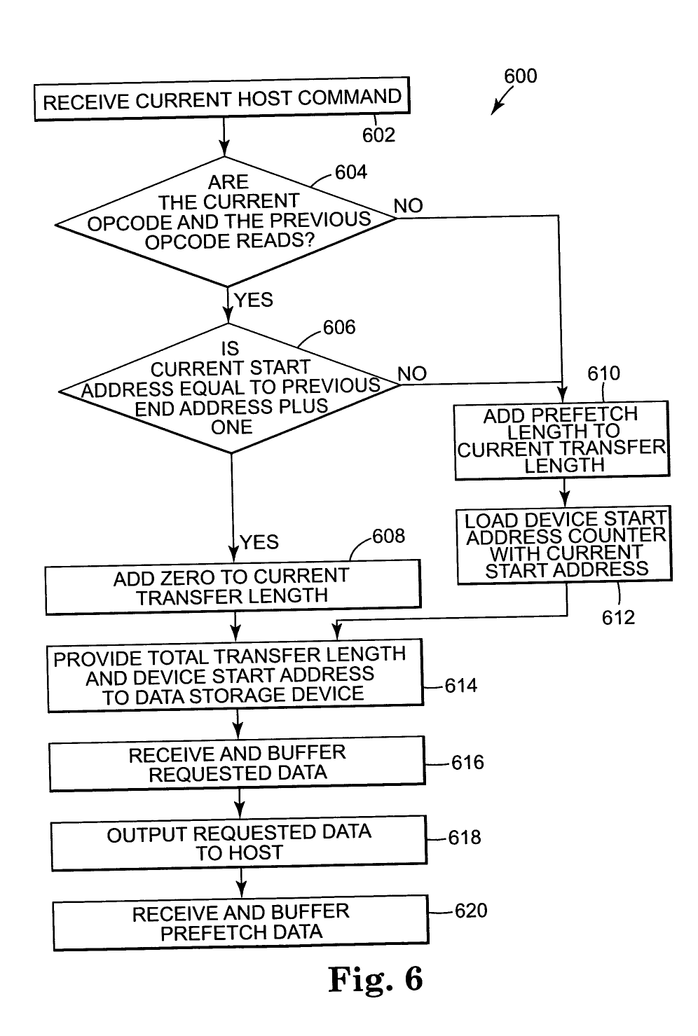

FIG. 6 is a flow diagram illustrating a method 600 for performing a memory prefetch according to one embodiment of the present invention. In one form of the invention, memory control system 104 (FIG. 1) is configured to perform method 600.

In step 602 of method 600, memory control system 104 receives a host command (current host command) from host electronic device 102. In step 604, sequential read detector 206 (FIG. 2) compares the opcode specified in the current host command to the READ opcode, compares the opcode specified in the previously received host command to the READ opcode, and determines whether both of the opcodes specify READ operations. If it is determined in step 604 that both opcodes do not specify READ operations, the method 600 moves to step 610 (described below). If it is determined in step 604 that both opcodes specify READ operations, the method 600 moves to step 606.

In step 606, sequential read detector 206 increments the end address of the previously received host command by a value of one, compares the incremented previous end address to the current start address specified in the current host command, and determines whether the two compared addresses are equal. If it is determined in step 606 that the current start address and the incremented previous end address are not equal, the method moves to step 610. If it is determined in step 606 that the current start address and the incremented previous end address are equal, the method moves to step 608.

In step 608, I/O controller 118 adds a prefetch length value of zero to the transfer length value specified in the current host command, with the sum being a value representing the total transfer length, and the method 600 moves to step 614 (described below). If it is determined in step 604 that the previous opcode and the current opcode do not both specify READ operations, or if it is determined in step 606 that the current start address and the incremented previous end address are not equal, in step 610, I/O controller 118 adds a non-zero prefetch length value to the transfer length value specified in the current host command, with the sum being a value representing the total transfer length, and the method 600 moves to step 612. In step 612, the device start address counter 420 is loaded with the start address specified in the current host command, and the method 600 moves to step 614.

In step 614, the total transfer length generated by I/O controller 118 (in step 608 or step 610), and the value in device start address counter 420, are provided to data storage device 106 (FIG. 1). In step 616, data buffer 416 receives and stores the data that was requested in the current host command and output by data storage device 106. In step 618, the requested data that was stored in data buffer 416 is output to host electronic device 102. In step 620, data buffer 416 receives prefetch data, if any, output by data storage device 106, and stores the prefetch data for access by a subsequent sequential READ command.

One form of the present invention provides a prefetch controller that uses hardware to detect sequential read operations and perform prefetch operations. Prefetch operations are performed more efficiently by the hardware of one aspect of the invention than previous devices that use firmware to program a prefetch as a separate internal transfer following the current transfer requested by the host.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A prefetch controller for controlling retrieval of data from a data storage device in response to a current host command received from a host device, the prefetch controller comprising:
a sequential read detector configured to generate a new sequential read indication for the current host command if the current host command and a previously received host command specify read operations that are non-sequential; and
a transfer length generator configured to provide a first transfer length value to the data storage device if the new sequential read indication is generated for the current host command, and provide a second transfer length value to the data storage device if the new sequential read indication is not generated for the current host command.

2. The prefetch controller of claim 1, wherein the first transfer length value is larger than the second transfer length value.

3. The prefetch controller of claim 1, wherein the sequential read detector comprises:
operation compare logic configured to compare an operation specified in the current host command to an operation specified in the previously received host command, and generate a first indication for the current host command if the compared operations are both read operations.

4. The prefetch controller of claim 3, wherein the sequential read detector further comprises:
address compare logic configured to compare a first address associated with the current host command to a second address associated with the previously received host command, and generate a second indication for the current host command if the compared addresses are indicative of sequential operations.

5. The prefetch controller of claim 4, wherein the sequential read detector further comprises:
a sequential read indication generator configured to generate the new sequential read indication if the first and the second indications are not generated for the current host command.

6. The prefetch controller of claim 1, wherein the sequential read detector comprises:
a plurality of registers for storing an opcode specified in the current host command, an opcode specified in the previous host command, a start address associated with the current host command, and an end address associated with the previous host command.

7. The prefetch controller of claim 6, wherein the sequential read detector further comprises:
opcode compare logic for comparing the stored opcodes;
address increment logic for incrementing the stored end address, thereby generating an incremented end address; and
address compare logic for comparing the stored start address and the incremented end address.

8. The prefetch controller of claim 7, wherein the sequential read detector further comprises:
a sequential read indication generator configured to generate the new sequential read indication based on outputs of the opcode compare logic and the address compare logic.

9. The prefetch controller of claim 1, wherein the transfer length generator comprises:
a first register for storing a prefetch value;
a second register for storing a zero value; and
a multiplexer coupled to the first and the second registers, the multiplexer responsive to the new sequential read indication for selectively outputting the prefetch value or the zero value.

10. The prefetch controller of claim 9, wherein the transfer length generator further comprises:
a third register for storing a transfer length value specified in the current host command.

11. The prefetch controller of claim 10, wherein the transfer length generator further comprises:
an adder for adding the value stored in the third register and the value output by the multiplexer.

12. A method of transferring data between a host electronic device and a data storage device, the method comprising:
receiving a current read command from the host electronic device, the current read command specifying a first transfer length value;
identifying whether the current read command is non-sequential to a previously received read command;
adding a prefetch length value to the first transfer length value if the current read command and the previous read command are non-sequential, thereby generating a second transfer length value; and
outputting the second transfer length value to the data storage device.

13. The method of claim 12, and further comprising:
buffering a first set of data received from the data storage device, the first set of data corresponding to the first transfer length value; and
outputting the buffered first set of data to the host electronic device.

14. The method of claim 13, and further comprising:
buffering a second set of data received from the data storage device, the second set of data corresponding to the prefetch length value; and
outputting the buffered second set of data to the host electronic device in response to a subsequently received sequential read command.

15. The method of claim 12, wherein the step of identifying whether the current read command is non-sequential comprises:
comparing opcodes specified in commands received from the host electronic device; and
comparing address information associated with the commands received from the host electronic device.

16. The method of claim 12, and further comprising:
adding a zero value to the first transfer length value if the current read command and the previous read command are sequential, thereby generating the second transfer length value.

17. A memory device comprising:
storage means for storing data;
host interface means for receiving host commands from a host electronic device;
sequential read detection means for identifying whether a current host command specifies a non-sequential read operation; and
transfer length generation means for adding a prefetch length value to a transfer length value specified in the current host command if the current host command specifies a non-sequential read operation, the transfer length generation means configured to output a sum of the prefetch length value and the transfer length value to the storage means.

18. The memory device of claim 17, wherein the sequential read detection means comprises:
means for comparing an operation specified in the current host command to an operation specified in a previously received host command; and
means for comparing a first address associated with the current host command to a second address associated with the previously received host command.

19. The memory device of claim 17, wherein the transfer length generation means comprises:
first register means for storing the prefetch length value;
second register means for storing a zero value;
multiplexing means for selectively outputting the prefetch length value or the zero value based on an output of the sequential read detection means; and
adding means for adding an output of the multiplexing means and the transfer length value specified in the current host command.

20. A computer-readable medium having computer-executable instructions for performing a method of transferring data between a host electronic device and a data storage device, the method comprising:
receiving a current host command from the host electronic device;
generating a new sequential read indication for the current host command if the current host command and a previously received host command specify read operations that are non-sequential;
outputting a first transfer length value to the data storage device if the new sequential read indication is generated for the current host command; and
outputting a second transfer length value to the data storage device if the new sequential read indication is not generated for the current host command, the second transfer length value less than the first transfer length value.

21. The computer-readable medium of claim 20, wherein the first transfer length value is larger than the second transfer length value.

22. The computer-readable medium of claim 20, wherein the method further comprises:
comparing an operation specified in the current host command to an operation specified in the previously received host command; and
generating a first indication for the current host command if the compared operations are both read operations.

23. The computer-readable medium of claim 22, wherein the method further comprises:
comparing a first address associated with the current host command to a second address associated with the previously received host command; and
generating a second indication for the current host command if the compared addresses are indicative of sequential operations.

24. The computer-readable medium of claim 23, wherein the new sequential read indication is generated only if the first and the second indications are not generated for the current host command.

25. The computer-readable medium of claim 20, wherein the method further comprises:
storing an opcode specified in the current host command, an opcode specified in the previous host command, a start address associated with the current host command, and an end address associated with the previous host command.

26. The computer-readable medium of claim 25, wherein the method further comprises:
comparing the stored opcodes;
incrementing the stored end address, thereby generating an incremented end address; and
comparing the stored start address and the incremented end address.

27. The computer-readable medium of claim 26, wherein the new sequential read indication is generated based on results of the opcode comparisons and the address comparisons.

28. The computer-readable medium of claim 20, wherein the method further comprises:
storing a prefetch value;
storing a zero value; and
selectively outputting the prefetch value or the zero value based on whether the new sequential read indication is generated for the current host command.

29. The computer-readable medium of claim 28, wherein the method further comprises:
storing a transfer length value specified in the current host command.

30. The computer-readable medium of claim 29, wherein the method further comprises:
adding the stored transfer length value and the selectively output value.
